(19) United States
(12) Patent Application Publication
(10) Pub. No.: US 2008/0051916 A1
(43) Pub. Date: Feb. 28, 2008

(54) METHOD AND APPARATUS FOR RECORDING STREAMED AUDIO

(75) Inventor: Steven Morris, Hsinchu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ARCADYAN TECHNOLOGY CORPORATION, Hsinchu (TW)

(21) Appl. No.: 11/467,572

(22) Filed: Aug. 28, 2006

(51) Int. Cl. G06F 17/00

(52) U.S. Cl. 700/94

(57) ABSTRACT

A method and an apparatus of recording from an audio stream are provided. The method receives and caches the audio stream. It is determined whether a track corresponding to at least an attribute begins by detecting a period of silence and by analyzing metadata of the audio stream. If so, a start is marked in the cached audio stream. Next, it is determined whether the track ends by detecting a period of silence and by analyzing metadata of the audio stream. If so, an end is marked in the cached audio stream. Finally, an audio file is created based on a section of the cached audio stream indicated by the start and end marked in the cached audio stream.

### BACKGROUND OF THE INVENTION

1. Field of the Invention

The invention relates in general to the method for recording streamed audio and more particularly to the method and apparatus for recording streamed audio based on attributes.

2. Description of the Related Art

Many radio stations currently stream their shows over the internet as well as broadcasting them. This enables the radio stations to reach a much larger audience for a small extra cost. For users wishing to record radio content, however, there is currently no easy means of recording individual songs. While PVPR (Personal Video Recorder) systems for television (both analog and digital) are common, no such device currently exists for radio broadcasts. The main reason for this is scheduling: the unit of content for a TV stations is usually the TV show, which leads to a fairly simple schedule that is easy to publish and follow. The unit of content for a radio station is often the song, which makes schedules extremely hard to publish in advance and follow accurately.

For some types of show (e.g. those were songs are requested by the listeners) these schedules are impossible to publish. Recording part of a streaming audio service is also complicated by the content format used to stream that service: to play the audio successfully, most devices need access to information that is only provided when the recorder first connects to the service.

Despite this, there is an interest in recording radio shows—either entire shows that may be of interest, or specific songs/artists that may not be available to the user on otherwise.

### SUMMARY OF THE INVENTION

It is therefore an object of the invention to provide a method and an apparatus for recording streamed audio based on one or more attributes of user's preference.

The invention achieves the above-identified objects by providing a method of recording from an audio stream. The method includes the following steps, The audio stream is received and cached. It is determined whether a track corresponding to at least an attribute begins by detecting a period of silence and by analyzing metadata of the audio stream and, if yes, marking a start in the cached audio stream. Next, it is determined whether the track ends by detecting a period of silence and by analyzing metadata of the audio stream and, if yes, marking an end in the cached audio stream. Finally, an audio file is created based on a section of the cached audio stream indicated by the start and end marked in the cached audio stream.

The invention achieves the above-identified objects by further providing an apparatus of recording from an audio stream. The recording apparatus includes an interface, a storage unit, and a processor. The interface receiving an attribute. The storage unit receives and caches the audio stream. The processor determines whether a track, corresponding to the attribute, begins by detecting a period of silence and by analyzing metadata of the audio stream and, if yes, marking a start in the cached audio stream. Then the processor determines whether the track ends by detecting a period of silence and by analyzing metadata of the audio stream and, if yes, marking an end in the cached audio stream. Finally, the processor creates an audio file based on a section of the cached audio stream indicated by the start and end marked in the cached audio stream.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 shows a block diagram of an internet radio recorder.

FIG. 2 shows a flow chart of a method for recording streamed audio

FIG. 3A shows a flowchart of the start-detecting step.

FIG. 3B shows a flowchart of the end-detecting step.

### DETAILED DESCRIPTION OF THE INVENTION

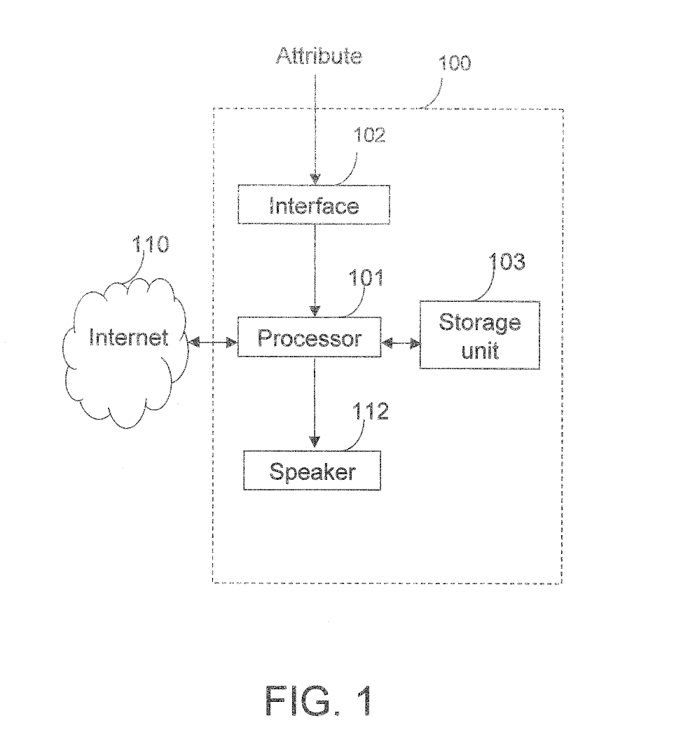

FIG. 1 shows a block diagram of an embodiment of an internet radio recorder, The internet radio recorder 100 includes a processor 101, an interface 102, and a storage unit 103 such as a memory or hard disk drive. To listen to radio, the user selects an internet radio station or an audio stream service via the man-machine interface 102, and the recorder 100 will then request that station from the internet radio server belonging to the radio station via the internet 110. In another embodiment, the recorder 100 can link to a unit such as a computer or a network device for communicating with an audio stream service. Audio data is then streamed from the server to the recorder 100, decoded on the recorder 100 and, optionally, played and outputted to an earphone or a speaker 112 which may be equipped externally or internally. In the embodiment, the processor 101 is programmed to record a piece of audio content, for example, a show or song corresponding to at least an attribute entered or selected by the user, and create a desired audio file accordingly. The processor 101, such as a microprocessor or microcontroller, determines whether desired audio content begins or ends in the audio stream. The processor 101 marks a start and an end in stored or cached content of the audio stream in the storage unit 103 according to the determination. The processor 101 further creates the desired audio file based on a section of the cached content indicated by the start and end marked in the cached content.

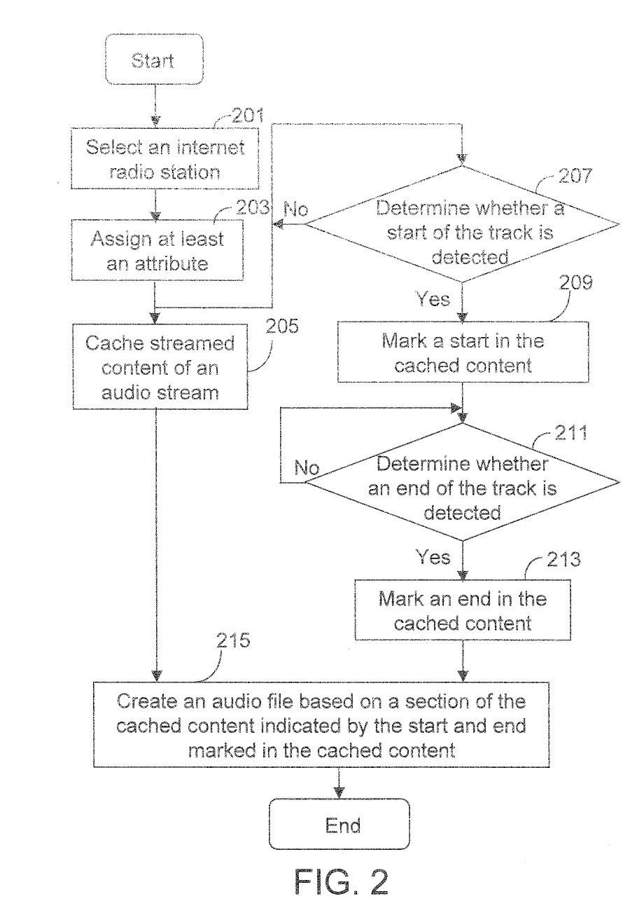

FIG. 2 shows a flow chart of a method for recording streamed audio from an internet radio station. The method starts at step 201 by the user to select one or more internet radio stations that he/she wishes to record content from. Then, in step 203, the user assigns one or more attributes describing content that is preferred to be recorded, for example, by entering data or selecting from a list through the interface 102. The attribute can be a keyword or a list of keywords, such as song names, artists or genres, or a show name. Then, in step 205, the recorder 100 receives the audio stream and caches the streamed content of the audio stream in its compressed form on the storage unit 103. For further usage, the recorder 100 may additionally store the information from the content header, which describes how the audio stream is encoded, for example, the bit rate, number of channels, and sample rate of the content.

While caching the streamed content in step 205, the recorder 100 performs steps 207-213 for recording a track that corresponds to the attributes assigned by the user. The track can be regarded generally as a piece of audio content, such as a song or a show. In step 207, the recorder 100 determines whether a start of a track corresponding to the attributes is detected. In step 209, if detected, a start is marked in the cached content, i.e. the streamed content of the audio stream that is cached as mentioned in step 205. Next, the recorder 100 determines whether an end of that track is detected at step 211. If detected, an end is marked in the cached content, as indicated in step 213. Finally, the recorder 100 creates a new audio file, using the previously-stored stream description and appending the marked section of the cached content. The user may then play the recorded file either on the recorder or on another playback device. The detecting steps 207 and 211 respectively for marking the start and end of the song corresponding to the attributes are further discussed as follows.

Finding the start and the end of a track in the audio stream from the internet radio station is difficult. One approach to identify the breaks of songs, tracks, or shows uses the metadata that describes the content of the audio stream, for example, the artist, song name, announcer, host, and/or name of the show. However, the location of the metadata giving such information is often not synchronized with the start of the track because of restrictions imposed by the audio format. The second approach to identity the breaks of tracks is to check the periods of silence of the decoded audio signal; however, the track may contain periods of silence in itself.

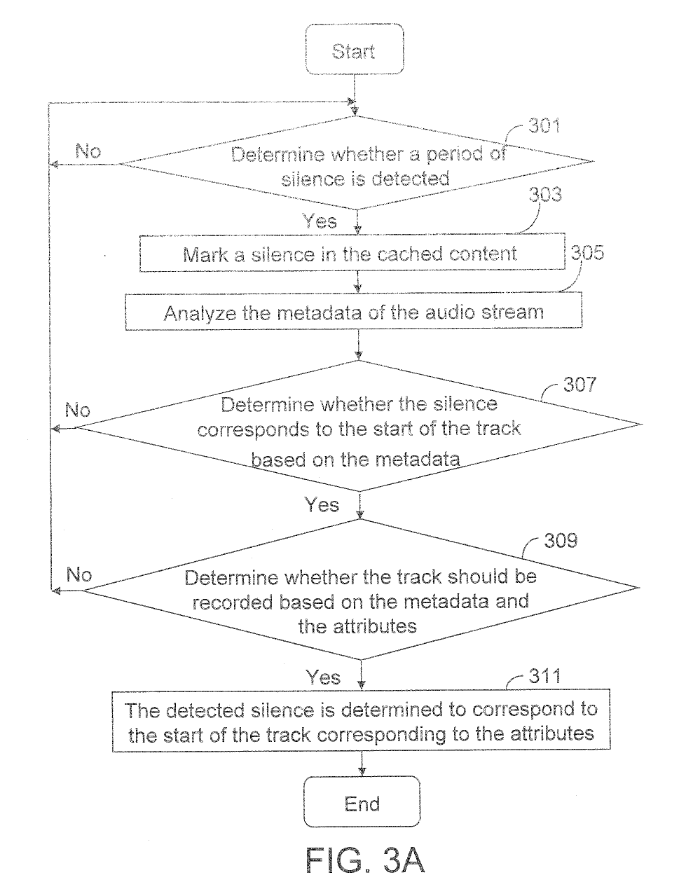

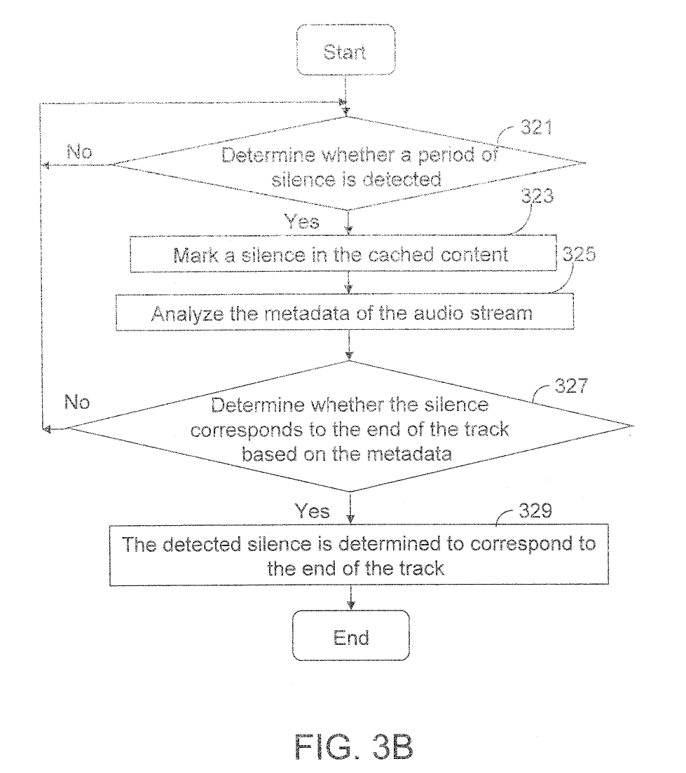

In order to solve the problem, a combination of above two approaches is used in one embodiment. The recorder 100 determines the start and end of a track by detecting the period of silence and a change in the metadata within a period of silence, e.g. about 1 or 2 seconds. Since the metadata may not be available until the track is already playing, the recorder 100 has to keep a cache of the downloaded audio stream and mark possible start/end points for clips. This downloaded audio stream must be cached until a start/end point is definitely identified. The detection steps 207 and 211 are further described in detail in FIG. 3A and FIG. 3B, respectively.

FIG. 3A shows a flowchart of an embodiment of the start-detecting step 207. The recorder 100 first detects whether a period of silence is detected, in step 301. In step 303, if detected, a silence is marked in the cached content as mentioned in step 205. Then the current metadata within or after the silence is analyzed, as shown in step 305. Next, in step 307, it is determined whether the detected silence is the start of a new track, based on the metadata, for example, by comparing the current metadata with the previous metadata. The track after the silence is a new one if the metadata is different from the previous one; if not, the method proceeds to step 301. In step 309, it is determined whether the track is to be recorded based on the metadata and the attributes. For example, the attributes assigned by the user are compared with the current metadata to determine whether the new track is to be recorded. If the current metadata corresponds to the attributes, it is determined that the silence can be regarded as the star of the track, as indicated in step 311.

FIG. 3B shows a flowchart of an embodiment of the end-detecting step 211. The recorder 100 first determines whether a period of silence is detected in step 321. In step 323, if detected, a silence is marked in the cached content. Then the current metadata within or after the silence is analyzed, as shown in step 325. Next, in step 327, it is determined whether the detected silence is the end of a new track, based on the metadata, for example, by comparing the current metadata with the previous metadata. If the current metadata is different from the previous one, the silence corresponds to the end of the track, as indicated in step 239; or else the method proceeds to step 321.

The method for recording streamed audio according to the embodiment of the invention can find the correct content by period of silence and the metadata contained in the audio stream, and schedule a recording. The method makes recording specified content from the audio stream significantly easier for the user, because the users need not know the exact time at which the track begins and ends, especially when the track is a song. For other types of content, e.g. a continuing series such as language class or documentary series, the embodiment makes it easier to record the entire series. Furthermore, a portable device, such as a digital music player, a personal digital assistant, or a mobile phone, which is capable of storing data and communicating with an audio stream service, can regarded as and be implemented as the internet radio recorder 100, as embodied above. The embodiment can be applied even in relatively low-end devices that feature some storage and recording capability.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method of recording from an audio stream, the method comprising:
receiving and caching the audio stream;
determining whether a track corresponding to at least an attribute begins by detecting a period of silence and by analyzing metadata of the audio stream and, if so, marking a start in the cached audio stream,
determining whether the track ends by detecting a period of silence and by analyzing metadata of the audio stream and, if so, marking an end in the cached audio stream; and
creating an audio file based on a section of the cached audio stream indicated by the start and end marked in the cached audio stream.

2. The method according to claim 1, wherein the star-determining step comprises:
marking a silence in the cached audio stream if detecting a period of silence;
analyzing the metadata of the audio stream; and
determining whether the period of silence corresponds to the start of a new track by comparing the analyzed metadata with previous metadata and by comparing the analyzed metadata with the attribute.

3. The method according to claim 2, wherein the analyzing step is executed after the period of silence.

4. The method according to claim 2, wherein the start of the new track is determined if the analyzed metadata differs from the previous metadata and that the analyzed metadata corresponds to the attribute.

5. The method according to claim 1, wherein the end-determining step comprises:
marking a silence in the cached audio stream if detecting a period of silence;
analyzing the metadata of the audio stream; and
determining whether the period of silence corresponds to the end of the track by comparing the analyzed metadata with previous metadata.

6. The method according to claim 5, wherein the analyzing step is executed after the period of silence.

7. The method according to claim 5, wherein the end of the track is determined if the analyzed metadata differs from the previous metadata.

8. An apparatus of recording from an audio stream, the apparatus comprising:
an interface for receiving an attribute;
a storage unit for receiving and caching the audio stream; and
a processor programmed to:
determine whether a period of silence occurs and analyze metadata of the audio stream so as to determine whether a track corresponding to the attribute begins in the audio stream;
mark a start in the cached audio stream when the track begins;
determine whether a period of silence occurs and analyze metadata of the audio stream so as to determine whether the track ends after the start is marked in the cached audio stream;
mark an end in the cached audio stream when the track ends; and
create an audio file based on a section of the cached audio stream indicated by the start and end marked in the cached audio stream.

9. The apparatus according to claim 8, wherein the processor, in order to determine the start of the track, is programmed to:
mark a silence in the cached audio stream when a period of silence is detected;
analyze the metadata of the audio stream; and
compare the analyzed metadata with previous metadata and compare the analyzed metadata with the attribute so as to determine whether the period of silence corresponds to the start of a new track.

10. The apparatus according to claim 9, wherein the processor analyzes the metadata after the period of silence.

11. The apparatus according to claim 9, wherein the processor determines the start of the track if the analyzed metadata differs from the previous metadata and that the analyzed metadata corresponds to the attribute.

12. The apparatus according to claim 8, wherein the processor, in order to determine the end of the track, is programmed to:
mark a silence in the cached audio stream if detecting a period of silence;
analyze the metadata of the audio stream; and
compare the analyzed metadata with previous metadata so as to determine whether the period of silence corresponds to the end of the track.

13. The apparatus according to claim 12, wherein the processor analyzes the metadata after the period of silence.

14. The apparatus according to claim 12, wherein the processor detects the end of the track if the analyzed metadata differs from the previous metadata.
